(19) United States
(12) Patent Application Publication
(10) Pub. No.: US 2008/0028111 A1
(43) Pub. Date: Jan. 31, 2008

(54) Method for signal processing of a general-purpose I/O interface and an apparatus thereof

(75) Inventors: Shun-Chin Lin, Chung Li City (TW); Bow-Yi Jang, Taoyuan City (TW)

Correspondence Address: LADAS & PARRY, 26 WEST 61ST STREET, NEW YORK, NY, 10023, US

(73) Assignee: BENQ CORPORATION

(21) Appl. No.: 11/811,602

(22) Filed: Jun. 11, 2007

(30) Foreign Application Priority Data
Jun. 15, 2006 (TW) 95121452

(51) Int. Cl. G06F 13/38

(52) U.S. Cl. 710/71

(57) ABSTRACT

A method for signal processing of a General-Purpose I/O (GPIO) interface is provided to have a data signal carried on a control signal. First, reset timing of the data signal to form a reset data signal. Then, have the reset data signal carried on the control signal.

### BACKGROUND OF THE INVENTION

(1) Field of the Invention

This invention relates to a method for signal processing, and more particularly relates to a method for signal processing of a general-purpose I/O (GPIO) interface.

(2) Description of the Prior Art

Programmable technologies for editing programs within the control core of electronic products, attending with a serial of testing and debug processes, are demanded for electronic product development, especially the increasing of available functions. The mentioned programmable control core can be a micro controller unit (MCU), a programmable logic device (PLD), a system on programmable chip (SoPC), and etc., and it usually includes three main composites, an operating unit, a memory, and an input/output (I/O) unit.

The operating unit is the central of computing, making decision, and controlling within the electronic product. The memory is utilized for saving system programs, such as the firmware. The I/O unit is utilized for receiving and delivering signals, and is designed to support interfaces of specific protocols, such as Universal Asynchronous Receiver-Transmitter (UART), pulse code modulation (PCM), Serial Peripheral Interface (SPI), I2C, and etc. In addition, the I/O unit usually has a general-purpose I/O (GPIO) interface for the programming demand of product designers.

FIGS. 1A and 1B are block diagrams showing the architecture of a typical control system. As shown in FIG. 1A, the control system 1 has a main body 10 and a peripheral device 11. The main body 10 is the core of the control system 1. The peripheral device 11 is a human-machine interface such as the illuminating device 110 and the button 111. The main body 10 has an operating unit 100 and an GPIO interface 101. Product designers can define the function of pins on the GPIO interface 101 according to the control system 1 by using the programming technology. For example, two pins GPIO 1 and 2 of the GPIO interface 101 shown in FIG. 1A can be defined for connecting to an illuminating device 110 and an input device with serial transmission like the button 111 respectively.

Besides transmitting signals to the peripheral device 11, the GPIO interface 101 may be also used to communicate with other integrated circuits. For example, the pins GPIO 3-10 shown in FIG. 1B are defined for communicating with an output device like the signal receiver 12 as shown, and the pins GPIO 11-15 are defined for communicating with an input device like the data source 13 as shown. Thus, the control system 1 may receive signals from the data source 13 and deliver signals to the signal receiver 12 through the GPIO interface 101.

The tendency of integrating various functions in the electronic product results in a more complicated timing control event. In addition, the electronic product usually needs greater designing flexibility about functions and standards so as to be success in the market. Thus, the GPIO interface of the electronic product in present faces the demands from the designer and the consumer about more transmitting signals or more peripheral devices.

However, these demands are limited by the number of pins on the GPIO interface. That is, the designer must abandon some presumed functions due to the limited number of pins, which hinders the functional development. An available method for solving this problem in present is to use an GPIO expander to increase the number of pins. However, this method may increase the cost and complicate the fabrication process.

Accordingly, the present invention focuses on providing a method to overcome the above mentioned difficulty by using the GPIO interface more efficiently to meet the demand about the electronic product development and also prevent the usage of GPIO expander.

### SUMMARY OF THE INVENTION

It is an object of the present invention to provide a method for signal processing of GPIO interface which uses one pin to transmit two different signals so as to increase definable functions on the GPIO interface.

It is another object of the present invention to increase functions defined on the GPIO interface without the need of GPIO expander so as to control the cost of the electronic product effectively.

A signal processing method using a control signal to carry a data signal is provided in the present invention. Firstly, reset the timing of the data signal to generate a reset data signal. Then, have the reset data signal carried on the control signal.

The control signal is composed of alternate first zones and second zones with different voltage levels. In an embodiment of the present invention, the first zone has a low voltage level, and the second zone has a high voltage level.

In an embodiment of the present invention, the resetting step adjusts the timing of the data signal corresponding to the first zone of the control signal.

In an embodiment of the present invention, the resetting step adjusts the timing of the data signal corresponding to a front region or a rear region of the first zone.

In an embodiment of the present invention, the resetting step adjusts the timing of the data signal, which corresponds to the second zone of the control signal, corresponding to the first zone of the control signal.

In an embodiment of the present invention, the resetting step adjusts the timing of the data signal, which corresponds to the second zone of the control signal and lasts longer than a predetermined period, corresponding to the first zone of the control signal.

In an embodiment of the present invention, the step of having the reset data signal carried on the control signal is to generate a selecting signal corresponding to the reset data signal and output the control signal or the reset data signal according to the selecting signal.

According to the above mentioned signal processing method, a signal processing apparatus is also provided in the present invention. The signal processing apparatus has a reset unit and an signal processing unit. The reset unit receives the data signal and resets the timing of the data signal to generate a reset data signal. The signal processing unit receives the control signal and the reset data signal, and has the reset data signal carried on the control signal to generate an output driving signal.

As mentioned above, the output driving signal is composed of the control signal and the data signal so as to achieve the object of transmitting two different signals by using one pin. Therefore, it is understood that the apparatus of the present invention has the potential to meet the demand from the electronic product development and prevent the usage of GPIO expander.

### BRIEF DESCRIPTION OF THE DRAWINGS

The present invention will now be specified with reference to its preferred embodiment illustrated in the drawings, in which:

FIGS. 1A and 1B are block diagrams showing the architecture of a typical control system;

FIG. 2A is a block diagram showing a preferred embodiment of the architecture of a control system in the present invention;

FIG. 2B is a block diagram showing a preferred embodiment of a signal processing device in the present invention;

FIG. 3 is a diagram showing a preferred embodiment of waveforms of the control signal and the data signal in the present invention;

FIG. 4 is a diagram with the waveforms to show a first preferred embodiment of the signal processing method in accordance with the present invention;

FIG. 5 is a diagram with the waveforms to show a second preferred embodiment of the signal processing method in accordance with the present invention; and

FIG. 6 is a diagram with the waveforms to show a third preferred embodiment of the signal processing method in accordance with the present invention.

### DESCRIPTION OF THE PREFERRED EMBODIMENTS

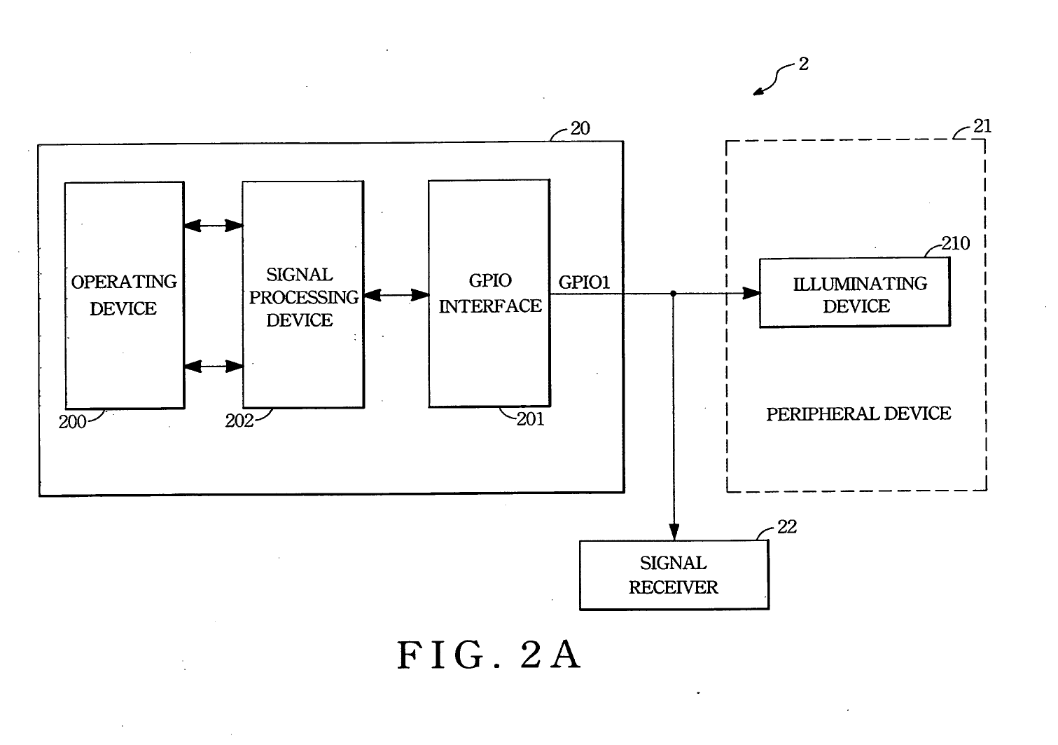

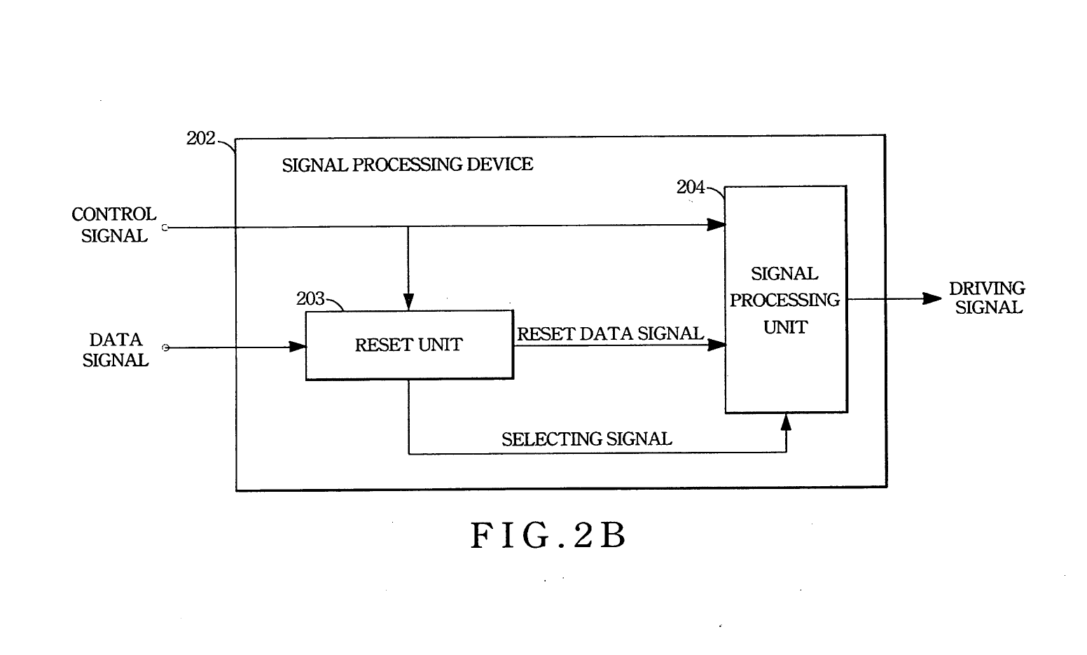

FIG. 2 is a block diagram showing a preferred embodiment of the architecture of a control system 2 in the present invention. As show, the control system 2 has a main body 20 and a peripheral device 21. The main body 20, which is the core of the control system 2 for achieving specific functions, has an operating device 200, a signal processing device 202, and a GPIO interface 201. A memory (not shown) may be also provided in the main body 20 for saving system programs. The peripheral device 21 is a human-machine interface for communicating between users and the control system 2. For example, the peripheral device 21 of the present embodiment has an illuminating device 210 as the output device of the control system 2 and some related circuits (not shown).

The pin GPIO 1 of the GPIO interface 201 is defined for driving the illuminating device 210. The illuminating device 210 may be a lamp or a light emitting diode (LED) for real time representing the operating state of the control system 2. For example, the illumination of the illuminating device 210 may be defined to represent that the control system 2 is working. In addition, as the control system 2 is a storage equipment such as a disk player, different flickering frequencies of the illuminating device 210 may be defined to represent different operating states such as reading data, playing music, writing data, and etc.

Since the peripheral device 21 is utilized mostly for communicating with the users, the design and setting of the peripheral device 21 must concern human related factors, such as critical flicker frequency (CFF) of human vision. That is, the flicker frequency of the illuminating device 210 cannot exceed CCF of human vision to guarantee that the flickering of the illuminating device 210 can be recognized by the users. Basically, CFF of human vision is varied with viewing angle and physical condition of users, but it usually locates between 20 Hz to 100 Hz. Thus, the flicker frequency of the illuminating device 210 cannot exceed 100 Hz or the flickering may not be recognized.

It is noted that the pin GPIO I in the present invention also connects to a data receiver 22 for transmitting data to the data receiver 22. The data receiver 22 may be an integrated circuit (such as a microprocessor or an operator) or a connector for communication with an external computing apparatus such as computer. In order to prevent the normal operation of the illuminating device 210 being influenced due to the existence of the data receiver 22, the data receiver 22 should be designed with high input resistance.

Also referring to FIG. 2A, the operating device 200 generates a control signal according to the operating states of the control system and a data signal. The control signal is utilized for driving the illuminating device 210 illuminating or flickering. The data signal is transmitted to the data receiver 22. The data signal may be a debug message or some derived message generated according to the operating state of the control system 2. The control signal and the data signal are then received by the signal processing device 202. The signal processing device 202 has a reset unit 203 and an signal processing unit 204. The reset unit 203 resets the timing of the data signal to generate a reset data signal. The signal processing unit 204 has the reset data signal carried on the control signal to generate an output driving signal, which not only drives the illuminating device 210 according to the control signal but also transmitting the data signal to the data receiver 22 just using one single pin GPIO 1.

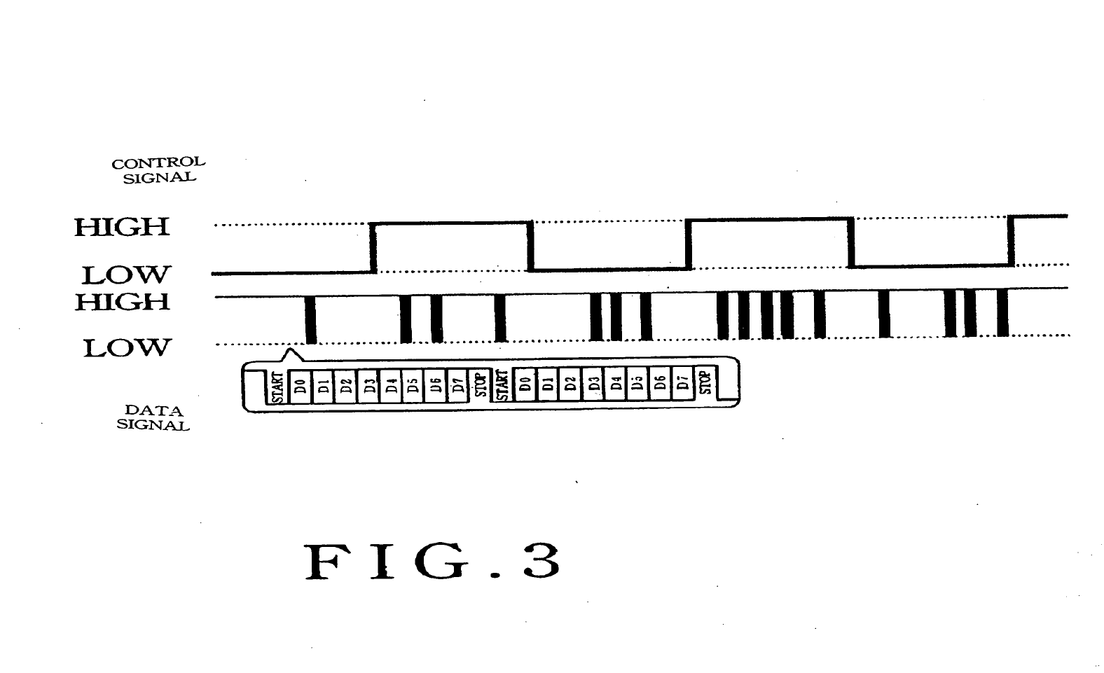

FIG. 3 is a diagram showing a preferred embodiment of the waveforms of the control signal and the data signal mentioned above. As shown, the control signal and the data signal are both digital pulse signals. The control signal is composed of alternate first zones with a low voltage level and second zones with a high voltage level so as to drive the illuminating device 210 flickering with a predetermined period.

The data signal may be generated by using a traditional universal asynchronous receiver and transmitter (UART) for serial communication, which transmits data bit by bit. A bite of data includes the content (D0˜D7), a starting bit (START), and a stopping bit (STOP). Since the transmission protocol about UART such as RS-232 transmission protocol is a well known transmission method, no further mentioned is provided in the specification.

Due to the limitation of critical flicker frequency (CFF) of user's vision, the predetermined period of the illuminating device 210 driven by the control signal must be longer than 50 ms (or a flicker frequency smaller than 20 Hz) and the data transmission speed of the data signal should be greater than 100 Hz to make sure that the flicker of the illuminating device 210 driven by the control signal is not influenced by the data signal. Take the traditional URAT protocol for example. The data transmission speed of data signal is usually ranged between 9600 Hz to 1152000 Hz, which is much greater than limitation of CFF mentioned above.

For a better understanding of the present invention, details about the signal processing method by using GPIO interface in accordance with the present invention is mentioned below with FIGS. 2, 2A, and 3 showing the related system architecture, waveforms of the control signal and the data signal.

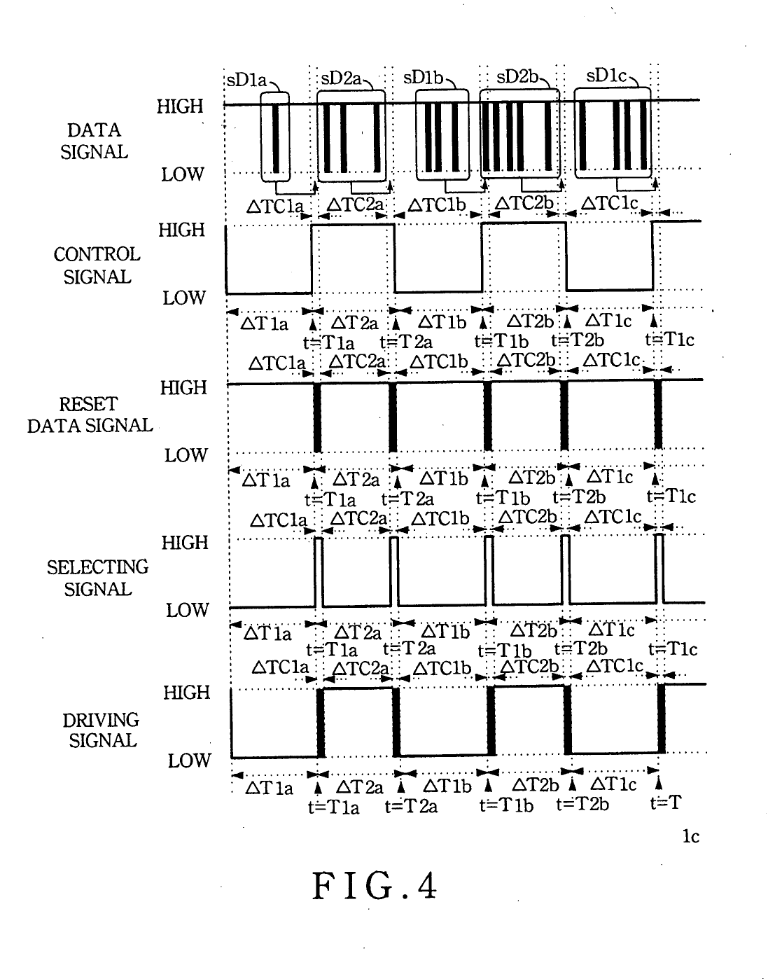

FIG. 4 shows a preferred embodiment of the signal processing method in accordance with the present invention. As shown, the control signal generated by the computing unit 200 to represent the real time operating state of the control system 2 is composed of alternate first zones ΔT₁ₐ,ΔT_{1b},ΔT_{1c} and second zones ΔT₂ₐ,ΔT_{2b}. The first zones ΔT₁ₐ,ΔT_{1b},ΔT_{1c} is provided with a low voltage level and the second zones ΔT₂ₐ,ΔT_{2b} is provided with a high voltage level. The first trigger time T₁ₐ,T_{1b},T_{1c} is the time the control signal being enhanced from the low voltage level to the high voltage level. The second trigger time T₂ₐ,T_{2b} is the time the control signal being declined from the high voltage level to the low voltage level. The above mentioned high voltage level on the control signal is utilized for driving the illuminating device 210 to illuminate. The above mentioned control signal is merely an embodiment of various control signals and should not form any limitation for the present invention.

The data signal, which is shown as pulses, can be sorted into the portion of data signal sD₁ₐ,sD_{1b},sD_{1c} corresponding to the first zones ΔT₁ₐ,ΔT_{1b},ΔT_{1c} and the portion of data signal sD₂ₐ,sD_{2b} corresponding to the second zones ΔT₂ₐ,ΔT_{2b}. The above mentioned resetting step is to adjust the timing of the data signal sD₁ₐ,sD_{1b},sD_{1c},sD₂ₐ,sD_{2b} corresponding to the front regions ΔTC₁ₐ,ΔTC_{1b},ΔTC_{1c} of the second zones ΔT₂ₐ,ΔT_{2b}, which start from the first trigger time T₁ₐ,T_{1b},T_{1c} and last with a predetermined period, or corresponding to the rear regions ΔTC₂ₐ,ΔTC_{2b} of the second zones ΔT₂ₐ,ΔT_{2b}, which last with a predetermined period and end at the second trigger time T₂ₐ,T_{2b}. As a preferred embodiment, the front regions ΔTC₁ₐ,ΔTC_{1b},ΔTC_{1c} or the rear regions ΔTC₂ₐ,ΔTC_{2b} last no longer than 10 ms.

The reset unit 203 of the signal processing device 202 is utilized for proceeding the above mentioned method to adjust the timing of the data signal sD₁ₐ,sD_{1b},sD_{1c} corresponding to the front regions ΔTC₁ₐ,ΔTC_{1b},ΔTC_{1c} of the second zones ΔT₂ₐ,ΔT_{2b}, and adjusts the timing of the data signal sD₂ₐ,sD_{2b} corresponding to the rear regions ΔTC₂ₐ,ΔTC_{2b} of the second zones ΔT₂ₐ,ΔT_{2b} to form a reset data signal.

The reset unit 203 also generates a selecting signal according to the reset data signal. The selecting signal in the present embodiment features a high voltage level corresponding to the front regions ΔTC₁ₐ,ΔTC_{1b},ΔTC_{1c} and the rear regions ΔTC₂ₐ, ΔTC_{2b} of the control signal in the present embodiment. Afterward, the signal processing unit 204 receives the selecting signal and outputs the control signal or the reset data signal according to the selecting signal to generate a driving signal. In detail, as the selecting signal is at the high voltage level, the reset data signal is output, as the selecting signal is at the low voltage level, the control signal is output. Thereby, the reset data signal is carried on the control signal.

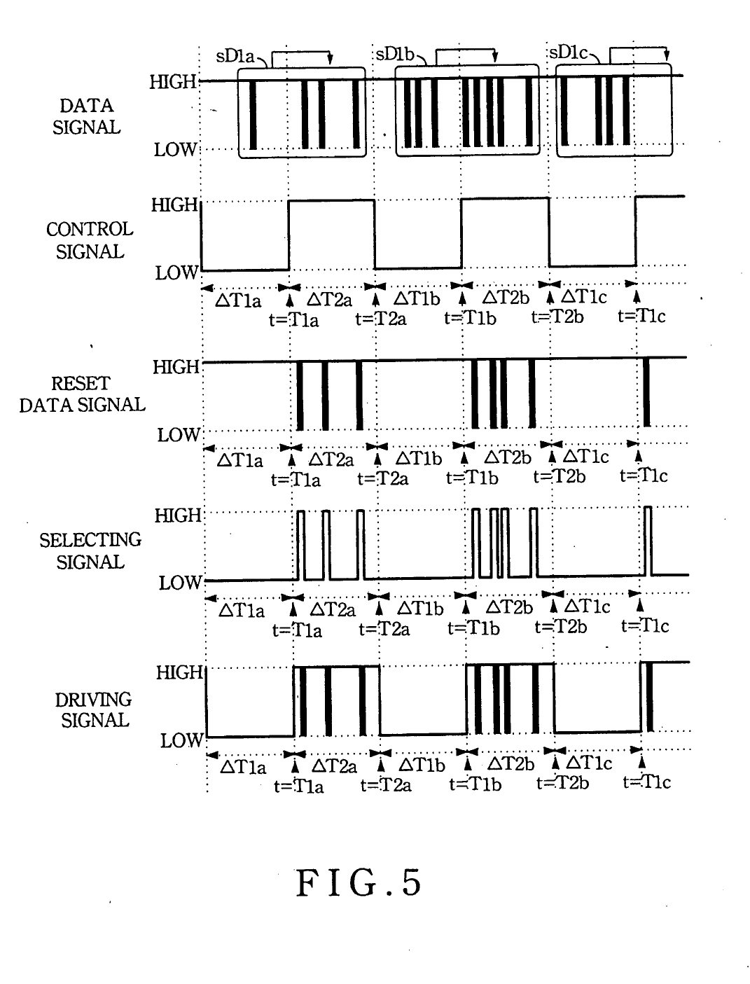

FIG. 5 shows a second preferred embodiment of the signal processing method in the present invention. In compared with the embodiment of FIG. 4, the present embodiment adjusts the timing of the data signal sD₁ₐ,sD_{1b},sD_{1c}, which corresponds to the first zones ΔT₁ₐ,ΔT_{1b},ΔT_{1c} of the control signal, corresponding to the second zones ΔT₂ₐ,ΔT_{2b}.

The abrupt flickering of the illuminating device 210 during a respectively longer period of illumination, which corresponds to the second zones ΔT₂ₐ,ΔT_{2b} of the control signal, is less significant than that the abrupt flickering during a period of darkness, which corresponds to the first zones ΔT₁ₐ,ΔT_{1b},ΔT_{1c} of the control signal. Therefore, it may not mess the control signal by adjusting the timing of the data signal sD₁ₐ,sD_{1b},sD_{1c}, which corresponds to the first zones ΔT₁ₐ,ΔT_{1b},ΔT_{1c}, corresponding to the second zones ΔT₂ₐ,ΔT_{2b}.

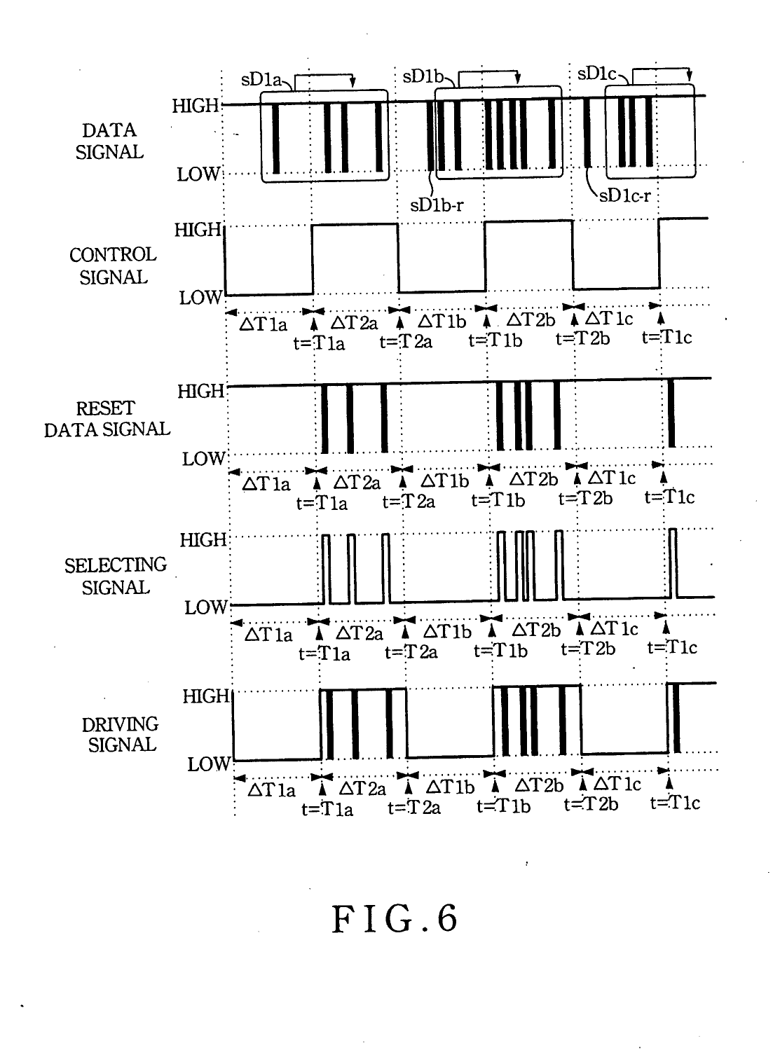

FIG. 6 shows a third preferred embodiment of the signal processing method in the present invention. The present embodiment adjusts the timing of the data signal sD₁ₐ,sD_{1b},sD_{1c}, which corresponds to the first zones ΔT₁ₐ,ΔT_{1b},ΔT_{1c} and lasts longer than a predetermined period such as 10 ms, corresponding to the second zones ΔT₂ₐ,ΔT_{2b}. The timing of the rest data signal sD_{1b-r},sD_{1c-r}, which lasts shorter than 10 ms, maintains unchanged for the flickering of illuminating device 210 due to the data signal sD_{1b-r},sD_{1c-r} is not significant.

It is noted that the driving signal output from the GPIO 1 is composed of the control signal and the data signal. Wherein, the portion of signal from the control signal is utilized for driving the illuminating device 210 with a plurality of predetermined period longer than 50 ms, and the portion of signal from the data signal may result the flickering of the illuminating device 210 with a period smaller than 10 ms (or a flicker frequency of 100 Hz). Since the flicker frequency of 100 Hz is greater than the CCF of human vision, users may only sense the flickering with period longer than 50 ms, which is the portion of signal from the control signal.

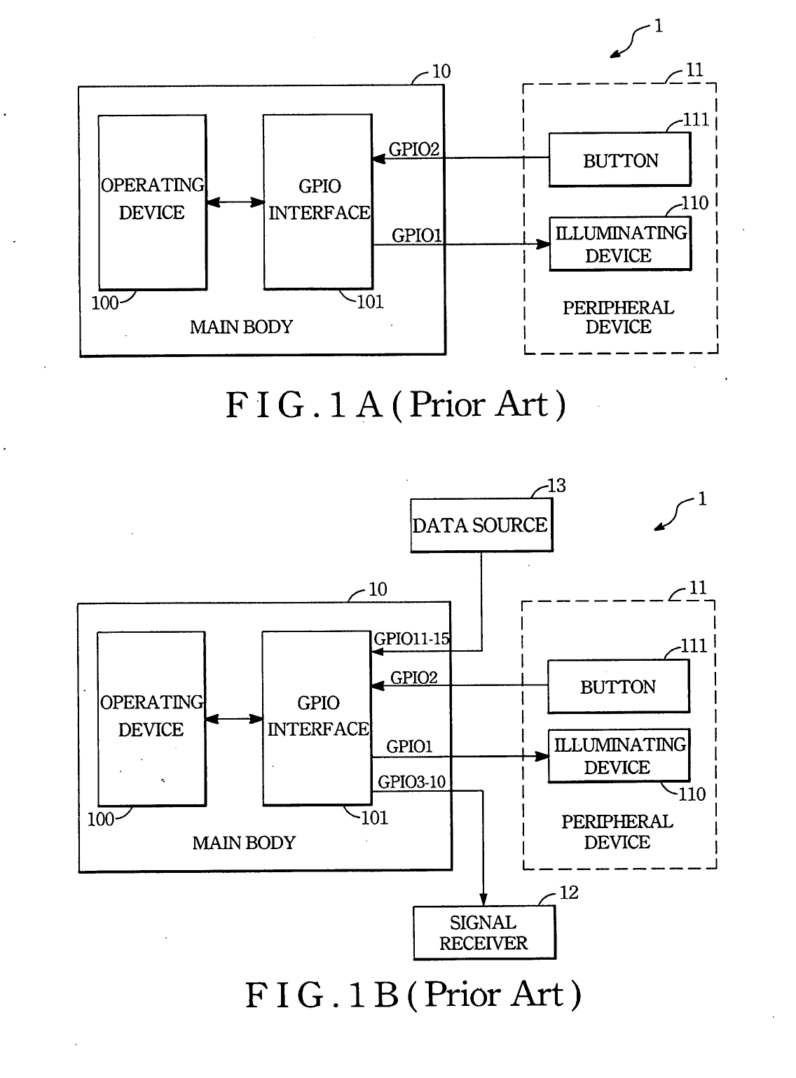

These embodiments describe the method of using one single pin GPIO 1 to drive the illuminating device 210 and transmit data signal to the data receiver 22 simultaneously. But it should not be a limitation of the present invention. Since it is understood that the GPIO interface is also capable for receiving signals, the idea provided in the present invention in no doubt can be used for receiving the control signal provided from a serial transmitting input device such as the button 111 of FIG. 1 and the data signal generated from a data source for writing serial number or calibration parameters into the main body 20 by using one single pin.

As mentioned, the method provided in the present invention combines the control signal and the data signal to form a driving signal to achieve the objects of delivering two different signals by using only one IO pin. Accordingly, it is understood that the GPIO interface can be used more efficiently for the demand from the electronic product development without the need of GPIO expander to save the cost.

While the embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A signal processing method using a control signal to carry a data signal comprising the steps of:
resetting timing of the data signal to generate a reset data signal; and
having the reset data signal carried on the control signal.

2. The signal processing method of claim 1, wherein the control signal is composed of alternate first zones and second zones with different voltage levels.

3. The signal processing method of claim 2, wherein the first zone has a low voltage level and the second zone has a high voltage level.

4. The signal processing method of claim 2, wherein the step of resetting the data signal is to adjust the timing of the data signal corresponding to the second zone of the control signal.

5. The signal processing method of claim 4, wherein the timing of the data signal is adjusted to corresponding to a front region or a rear region of the second zone of the control signal.

6. The signal processing method of claim 2, wherein the step of resetting the data signal is to adjust the timing of the data signal, which corresponds to the first zone, corresponding to the second zone of the control signal.

7. The signal processing method of claim 3, wherein the step of resetting the data signal is to adjust the timing of the data signal, which corresponds to the first zone of the control signal and lasts longer than a predetermined period, corresponding to the second zone of the control signal.

8. The signal processing method of claim 1, wherein the control signal is utilized to drive an illuminating device flickering with at least one predetermined period.

9. The signal processing method of claim 8, wherein the control signal is utilized to drive the illuminating device flickering with a plurality of periods longer than 50 ms.

10. The signal processing method of claim 1, wherein the data signal is generated by a universal asynchronous receiver and transmitter (UART).

11. The signal processing method of claim 1, wherein the step of having the reset data signal carried on the control signal is to form a selecting signal corresponding to the reset data signal and output the control signal or the reset data signal according to the selecting signal.

12. The signal processing method of claim 11, wherein the selecting signal corresponds to the timing of the reset data signal.

13. A signal processing apparatus utilized for having a data signal carried on a control signal comprising:
a reset unit, receiving the data signal and resetting timing of the data signal to generate a reset data signal; and
an signal processing unit, receiving the control signal and the reset data signal, and having the reset data signal carried on the control signal.

14. The signal processing apparatus of claim 13, wherein the control signal is composed of alternate first zones and second zones.

15. The signal processing apparatus of claim 14, wherein the first zone has a low voltage level and the second zone has a high voltage level.

16. The signal processing apparatus of claim 14, wherein the reset unit adjusts the timing of the data signal corresponding to the second zone of the control signal.

17. The signal processing apparatus of claim 16, wherein the reset unit adjusts the timing of the data signal corresponding to a front region or a rear region of the second zone of the control signal.

18. The signal processing apparatus of claim 15, wherein the reset unit adjusts the timing of the data signal, which corresponds to the first zone, corresponding to the second zone of the control signal.

19. The signal processing apparatus of claim 15, wherein the reset unit adjusts the timing of the data signal, which corresponds to the first zone and lasts longer than a predetermined period, corresponding to the second zone of the control signal.

20. The signal processing apparatus of claim 13, wherein the control signal is utilized to drive an illuminating device flickering with at least one predetermined period.

21. The signal processing apparatus of claim 20 wherein the control signal is utilized to drive the illuminating device flickering with a plurality of periods longer than 50 ms.

22. The signal processing apparatus of claim 13, wherein the data signal is generated by a universal asynchronous receiver and transmitter (UART) for serial communication.

23. The signal processing apparatus of claim 16 wherein the reset unit generates a selecting signal corresponding to the reset data signal, the signal processing unit has the reset data signal carried on the control signal by outputting the control signal or the reset data signal according to the selecting signal.
